(19) United States
(12) Patent Application Publication
(10) Pub. No.: US 2010/0053788 A1
(43) Pub. Date: Mar. 4, 2010

(54) METHOD OF MEASURING VARIATION IN FLOATING AMOUNT AND MAGNETIC STORAGE APPARATUS

(75) Inventor: Hiroshi Uno, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/510,597

(22) Filed: Jul. 28, 2009

(30) Foreign Application Priority Data
Sep. 4, 2008 (JP) 2008-226707

(51) Int. Cl. G11B 27/36

(52) U.S. Cl. 360/31; G9B/27.052

(57) ABSTRACT

A method for measuring a variation in the floating amount of a magnetic head comprising: measuring the ambient temperature which is a temperature of the magnetic storage apparatus; reading a signal recorded in the magnetic recording medium; measuring a signal value which is a value related to a signal read in the reading; and calculating a variation in the floating amount of the magnetic head based on relationship information which is information representing a relationship between the ambient temperature and signal value that have previously been measured, measurement value which is the ambient temperature measured in the measuring of the temperature, and signal value measured in the measuring of the signal.

### CROSS-REFERENCE TO RELATED APPLICATIONS

This application is based upon and claims the benefit of priority of the prior Japanese Patent Application No. 2008-226707, filed Sep. 4, 2008, the entire contents of which are incorporated herein by reference.

### FIELD

The present invention relates to a technique of measuring a variation in the floating amount of a magnetic head.

### BACKGROUND

A variation in the floating amount of a magnetic head with respect to a storage medium has conventionally occurred in a magnetic storage apparatus due to a variation in the atmospheric pressure or adhesion of foreign matters to a slider. It is known that such a variation in the floating amount (hereinafter, referred to “floating variation”) of the magnetic head can be calculated based on a variation in the level of a signal read out from the magnetic head. That is, assuming that r is disk radial position (m), rpm is disk rotation number (per minute), f is signal frequency (Hz), TAA1 is reference signal level (V), and TAA2 is readout signal level (V), the floating variation can be calculated according to the following Wallace's formula.

Floating variation=r/f×rpm/60×ln TAA1/TAA2

Further, a technique that uses the Wallace's formula to calculate the floating variation based on a reproduced output voltage is known (refer to, e.g., Patent Document 1: Japanese Laid-open Patent Publication No. 06-223523)

However, the level of a signal read out from the magnetic head may vary due not only to the floating variation but also to a temperature variation at data write time onto a storage medium and temperature variation of magnetic properties of a storage medium, making it difficult to measure the floating variation with high accuracy.

### SUMMARY

According to an aspect of the invention, a method for measuring a variation in the floating amount of a magnetic head for use in a magnetic storage apparatus that records a signal onto a magnetic recording medium using the magnetic head, the method comprising: measuring the ambient temperature which is a temperature of the magnetic storage apparatus; reading a signal recorded in the magnetic recording medium; measuring a signal value which is a value related to a signal read in the reading; and calculating a variation in the floating amount of the magnetic head based on relationship information which is information representing a relationship between the ambient temperature and signal value that have previously been measured, measurement value which is the ambient temperature measured in the measuring of the temperature, and signal value measured in the measuring of the signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a view illustrating a configuration of a magnetic storage apparatus according to a first embodiment of the present invention;

FIG. 2 is a view illustrating a configuration of a level measurement section;

FIG. 3 is a view illustrating waveforms of a readout signal and a substantially peak voltage;

FIG. 4 is an example of a graph illustrating a relationship between Hc and temperature;

FIG. 5 is a view illustrating a relationship between the magnitude of Hc and half-value width of a solitary wave;

FIG. 6 is an example of a graph illustrating a relationship between ambient temperature and readout signal level;

FIG. 7 is a flowchart illustrating operation of the magnetic storage apparatus according to the first embodiment;

FIG. 8 is a view illustrating a correspondence between ambient temperature and ratio of the signal level relative to the signal level at a reference temperature;

FIG. 9 is a flowchart illustrating operation of the magnetic storage apparatus according to the second embodiment;

FIG. 10 is a view illustrating a configuration of a magnetic storage apparatus according to the third embodiment;

FIG. 11 is a block diagram illustrating a configuration of an AGC circuit; and

FIG. 12 is a view illustrating a configuration of a magnetic storage apparatus according to the fourth embodiment.

### DESCRIPTION OF EMBODIMENTS

The present invention aims to exclude influences of a temperature variation at data write time onto a magnetic storage medium and temperature variation of magnetic properties of a magnetic storage medium from floating variation calculation processing based on a readout signal level so as to achieve accurate measurement of the floating variation. Hereinafter, embodiments of the present invention will be described with reference to the accompanying drawings.

### [a] First Embodiment

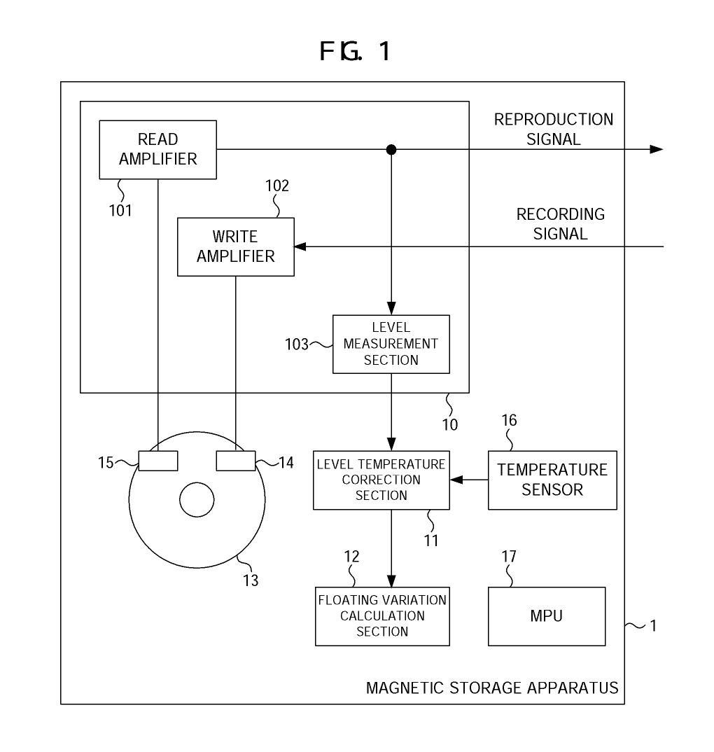

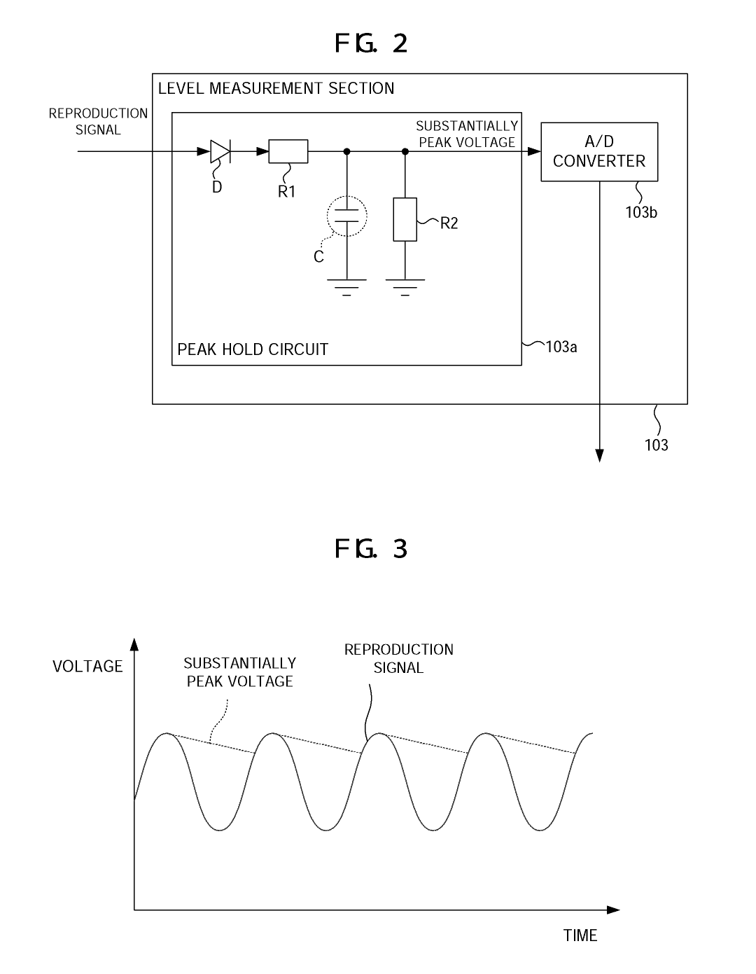

A magnetic storage apparatus according to the present embodiment will first be described. FIG. 1 is a view illustrating a configuration of a magnetic storage apparatus according to the present embodiment. FIG. 2 is a view illustrating a configuration of a level measurement section.

As illustrated in FIG. 1, a magnetic storage apparatus 1 according to the present embodiment includes a preamplifier 10, a level temperature correction section 11 (calculation section), a floating variation calculation section (calculation section), a magnetic disk 13 as a storage medium, a write head 14, a read head 15 (magnetic head), a temperature sensor 16 (temperature measurement section), and an MPU (Micro Processing Unit) 17.

The preamplifier 10 includes a read amplifier 101, a write amplifier 102, and a level measurement section (measurement section) 103.

The magnetic disk 13 is a magnetic storage medium used in the present embodiment and retains reference information to be described later in a predetermined storage area. The write head 14 is a magnetic head for writing a recording signal onto the magnetic disk 13. The read head 15 is a magnetic head for reading a signal that has been written onto the magnetic disk 13 as a reproduction signal. The write amplifier 102 amplifies a recording signal when the write head 14 writes it onto the magnetic disk 13. The read amplifier 101 amplifies a reproduction signal (readout signal) when the read head 15 reads it from the magnetic disk 13. The level measurement section 103 measures the level of the readout signal amplified by the read amplifier 101. The temperature sensor 16 is a sensor for measuring the ambient temperature of the magnetic storage apparatus 1. The temperature sensor 16 may be provided outside the magnetic storage apparatus 1. The level temperature correction section 11 corrects the level of the readout signal measured by the level measurement section 103 based on the ambient temperature measured by the temperature sensor 16 and reference information recorded in the magnetic disk 13. The floating variation calculation section 12 calculates the floating variation of magnetic heads (write head 14 and read head 15) based on the readout signal level corrected by the level temperature correction section 11 and other parameters. The functions of the level temperature correction section 11 and floating variation calculation section 12 are essentially executed by the MPU 17.

A configuration and operation of the level measurement section will next be described. FIG. 2 is a view illustrating a configuration of the level measurement section, and FIG. 3 is a view illustrating waveforms of a readout signal and a substantially peak voltage.

As illustrated in FIG. 2, the level measurement section 103 is constituted by a peak hold circuit 103a and an A/D converter 103b. The peak hold circuit 103a is a circuit having a diode D, a resistance R1, a resistance R2, and a capacitor C. The peak hold circuit 103a discharges electricity according to the time constant of the resistance R1 and capacitor C to attenuate a sine wave as a readout signal illustrated in the graph of FIG. 3 having a vertical axis representing voltage and a horizontal axis representing time. As a result, a substantially peak voltage indicated by a dotted waveform in the graph of FIG. 3 is extracted from the sine wave. The substantially peak voltage is converted into a digital value through the A/D converter, whereby level measurement data is obtained.

It is desirable that the frequency of the readout signal as a signal to be measured be as high as possible so that the temperature change based on an anti-magnetic force Hc to be described later of the magnetic disk 13 can be detected with high sensitivity. Therefore, in the present embodiment, an F2 signal having a frequency ½ of that of the Nyquist frequency F1 in a Partial Response Maximum-Likelihood (PRML) method is used for the preamble of data written in the magnetic disk 13 as a signal for the level measurement. In the level measurement of the F2 signal, an increase in the number of measurements for averaging can increase the measurement accuracy. The level measurement of the F2 signal can be achieved by using the preamble portion of the data, but also, e.g., by providing a special track for writing the F2 signal and applying a format for level measurement to the track. Further, the signal to be measured is not limited to the F2 signal but any signal, such as the preamble of a servo signal, may be used as far as the similar signals can be detected at a plurality of locations.

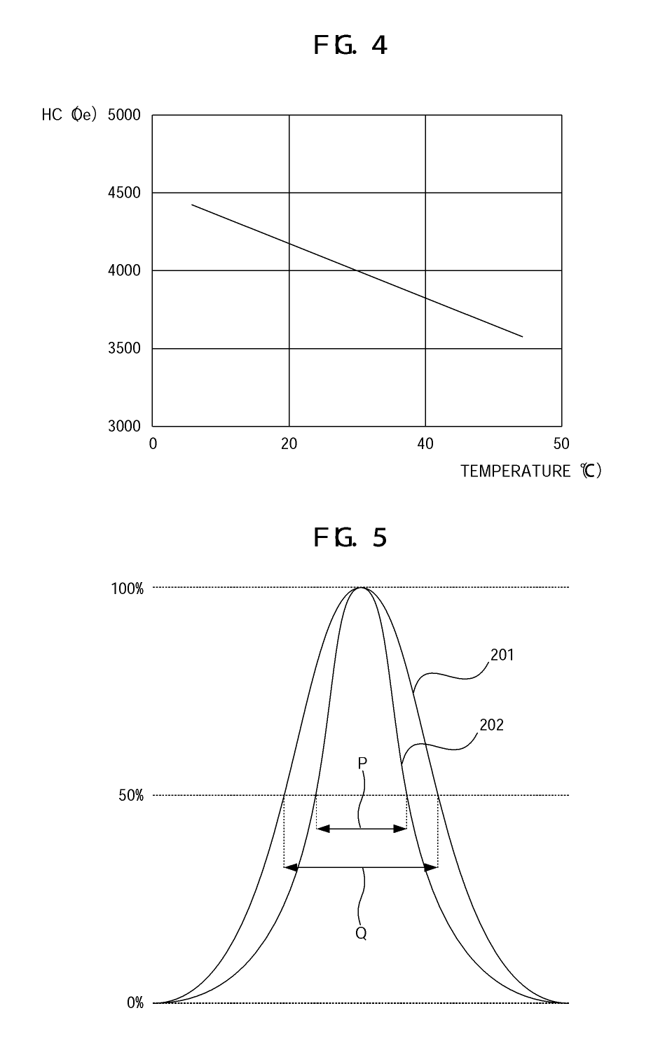

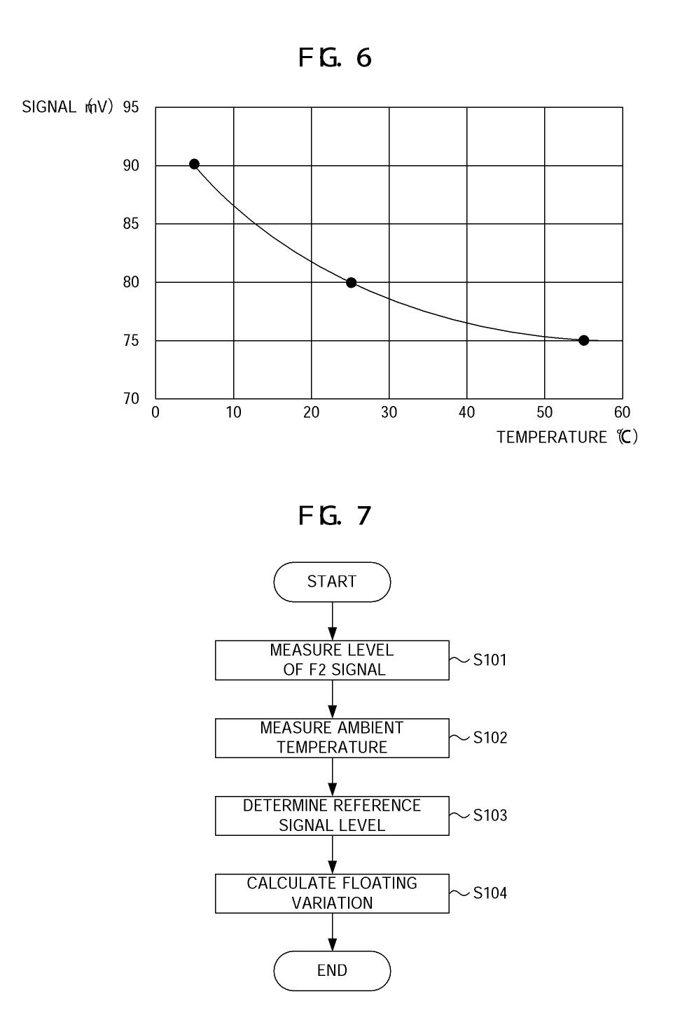

Further, the present invention is achieved by a use of properties that the anti-magnetic force Hc of a magnetic recording medium like the magnetic disk 13 used in the present embodiment greatly changes depending on temperature. FIG. 4 is an example of a graph illustrating a relationship between Hc and temperature. FIG. 5 is a view illustrating a relationship between the magnitude of Hc and half-value width of a solitary wave. FIG. 6 is an example of a graph illustrating a relationship between ambient temperature and readout signal level.

As illustrated in FIG. 4, the lower the temperature, the larger the Hc of the magnetic disk 13 becomes; and the higher the temperature, the smaller the Hc of the magnetic disk 13. Further, although the level of the solitary wave hardly changes with a change of the Hc, a half-value width Pw50 of the solitary wave changes with a change of the Hc. In FIG. 5, a half-value width Pw50 of a solitary wave 202 denoted by P, which is obtained when the Hc is large, becomes smaller than a half-value width Pw50 of a solitary wave 201 denoted by Q, which is obtained when the Hc is small. Further, the smaller the half-value width Pw50, the higher the resolution, and the high-frequency signal level becomes higher. Thus, the lower the ambient temperature of a magnetic storage apparatus, the larger the Hc thereof becomes as illustrated in FIG. 6 and, accordingly, the level of the high-frequency signal as the readout signal becomes higher.

The relationship between the ambient temperature and readout signal level as illustrated in FIG. 6 is derived from a fact that it is possible to exclude the influence of the temperature at the time of signal writing onto the magnetic disk 13 when saturated recording is achieved under any temperature condition and thereby the signal level can be determined based on only the temperature at the signal readout time.

The magnetic storage apparatus 1 according to the present embodiment writes a signal in the preamble portion of data recorded in the magnetic disk 13 by saturated recording and thereby excludes the influence of the temperature at the time of signal writing. Further, in the magnetic storage apparatus 1, the readout signal of a signal that has previously been written by saturated recording is measured at a plurality of ambient temperature points, and a correspondence between the readout signal level and each temperature is recorded in the magnetic disk 13 as reference information (relationship information). In the present embodiment, the relationship between the ambient temperature and readout signal level illustrated in FIG. 6 is defined as the reference information. The reference information is created by measuring the readout signal level at a plurality of temperature points using a constant temperature reservoir under ordinary pressure followed by application of interpolation or extrapolation. The reference information may have any structure as far as it represents a correspondence between the ambient temperature and readout signal level.

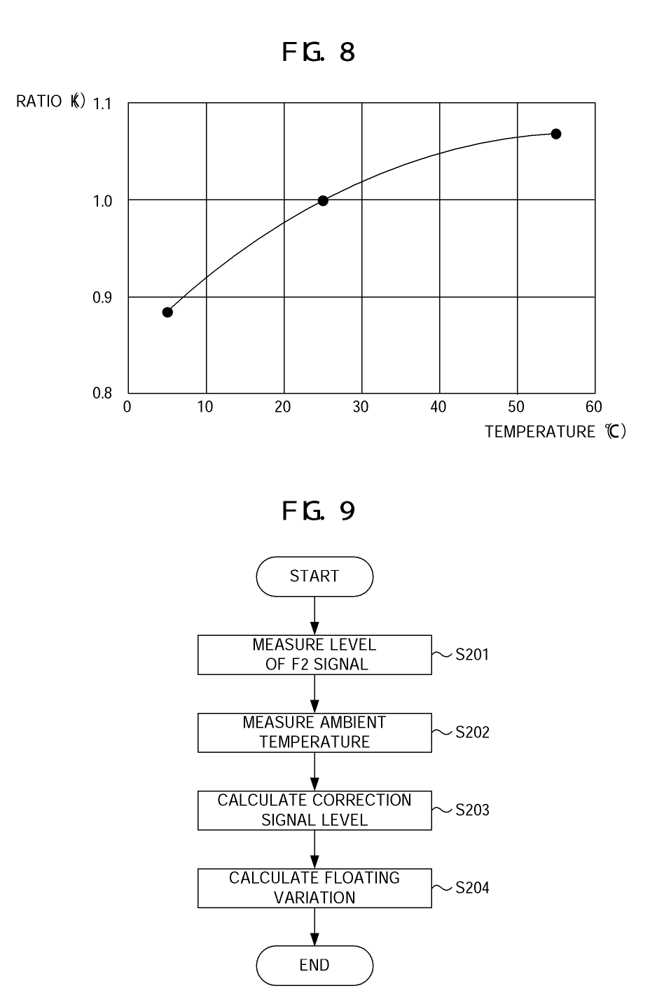

Operation of the magnetic storage apparatus according to the present embodiment will next be described. FIG. 7 is a flowchart illustrating operation of the magnetic storage apparatus according to the present embodiment. In FIG. 7, it is assumed that the F2 signal has previously been written in the preamble portion of data written in the magnetic disk.

The F2 signal written in the preamble portion is read out by the read head 15 from the magnetic disk 13 (readout step), and the readout signal is amplified by the read amplifier 101. The level of the F2 signal amplified by the read amplifier 101 is measured by the level measurement section 103 (S101, measurement step). At the same timing as the measurement, the ambient temperature of the magnetic storage apparatus 1 is measured by the temperature sensor 16 (S102, temperature measurement step).

After the measurement of the ambient temperature by the temperature sensor 16, the level temperature correction section 11 refers to the reference information recorded in the magnetic disk 13 to determine a signal level corresponding to the ambient temperature as a reference signal level (S103, calculation step). The floating variation calculation section 12 calculates the floating variation of the magnetic head based on the reference signal level and signal level of the F2 signal measured by the level measurement section 103 (S104, calculation step). A concrete calculation example is as follows.

Assuming that the signal level of the F2 signal measured by the level measurement section 103 is 75 mV and ambient temperature measured by the temperature sensor 16 is 10° C., a reference signal level of 87 mV is derived from the correspondence represented by the reference information. When the above values and other parameters are assigned to respective variables of the abovementioned Wallace's formula, floating variation=+3.08×10⁻⁹ m is obtained (disk radial position r=30×10⁻³ (m), rpm=5400 (/min), f=130×10⁶ (Hz), TAA1=87×10⁻³ (V@10° C.), TAA2=75×10⁻³ (V)).

As described above, according to the present embodiment, the floating variation can be obtained from the ambient temperature and readout signal, thus enabling measurement of presence/absence of the floating variation of the magnetic head due to some error. Further, a predetermined threshold (for example, 2 nm is set as the upper limit, and −1 nm is set as the lower limit) may be set for the floating variation, and an error message may be displayed on the higher-level device when the floating variation exceeds the set threshold.

### [b] Second Embodiment

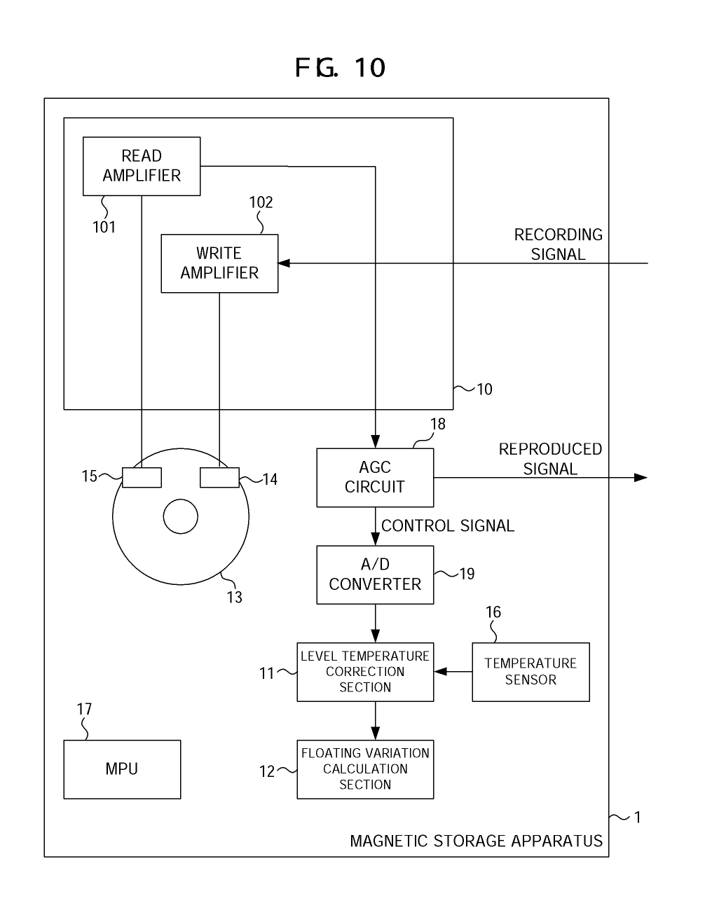

In the above first embodiment, the reference signal level is determined based on the correspondence between the ambient temperature and readout signal level, and the floating variation is calculated by assigning the level of the F2 signal read out from the magnetic disk 13 to the Wallace's formula. In the second embodiment, a readout signal level at a predetermined ambient temperature is previously fixed as the reference signal level, and the level of the F2 signal read out as a measurement signal is corrected, whereby the floating variation is calculated. Thus, the magnetic storage apparatus 1 according to the present embodiment differs from that of the first embodiment in that correction information (relationship information) is recorded in the magnetic disk 13 in place of the reference information. The configuration of the second embodiment other than this point is the same that of the first embodiment. Thus, hereinafter, a description will be given of only the correction information and operation of the magnetic storage apparatus 1. FIG. 8 is a view illustrating a correspondence between the ambient temperature and a ratio relative to the signal level at a reference temperature.

In the present embodiment, the correction information as illustrated in FIG. 8 is recorded in the magnetic disk 13 as information for correcting the F2 signal to be measured. The correction information represents a correspondence between the ambient temperature and a value indicating a ratio between the level of a signal at a reference temperature (25° C.) and the level of the same signal at each of the other temperatures. The correction information may have any structure as far as it represents a correspondence between the ambient temperature and ratio relative to the signal level at the reference temperature.

Operation of the magnetic storage apparatus according to the present embodiment will next be described. FIG. 9 is a flowchart illustrating operation of the magnetic storage apparatus according to the present embodiment. In FIG. 9, it is assumed that the F2 signal has previously been written in the preamble portion of data written in the magnetic disk.

The F2 signal written in the preamble portion is read out by the read head 15 from the magnetic disk 13 (readout step), and the readout signal is amplified by the read amplifier 101. The level of the F2 signal amplified by the read amplifier 101 is measured by the level measurement section 103 (S201, measurement step). At the same timing as the measurement, the ambient temperature of the magnetic storage apparatus 1 is measured by the temperature sensor 16 (S202, temperature measurement step).

After the measurement of the ambient temperature by the temperature sensor 16, the level temperature correction section 11 refers to the correction information recorded in the magnetic disk 13 and multiplies a ratio K corresponding to the ambient temperature and level of the F2 signal measured by the level measurement section 103 (S203, calculation step). The floating variation calculation section 12 calculates the floating variation of the magnetic head based on the reference signal level and signal level of the F2 signal corrected by the level temperature correction section 11 (S204, calculation step). A concrete calculation example is as follows. Note that it is assumed that the reference signal level in the present embodiment is a signal level at a temperature of 25° C.

Assuming that the signal level of the F2 signal measured by the level measurement section 103 is 100 mV and ambient temperature measured by the temperature sensor 16 is 10° C., K=0.93 is derived from the correction information illustrated in FIG. 6 and, accordingly, a corrected signal level of 93 mV is obtained. When the above values including the correction signal level and reference signal level and other parameters are assigned to respective variables of the abovementioned Wallace's formula, floating variation=−0.68×10⁻⁹ m is obtained (disk radial position r=30×10⁻³ (m), rpm=5400 (/min), f=130×10⁶ (Hz), TAA1=90×10⁻³ (V@25° C.), TAA2=93×10⁻³ (V@10° C.)).

As described above, according to the magnetic storage apparatus of the present embodiment, a signal level at a predetermined ambient temperature is set as the reference signal level, the level of the F2 signal is corrected based on a ratio relative to the reference signal level and measured ambient temperature, and the floating variation is calculated based on the reference signal level and corrected signal level.

Although the magnetic storage apparatus 1 calculates the floating variation based on the readout signal in the above first and second embodiments, the floating variation may be calculated based on a control signal generated in an AGC (Automatic Gain Control) circuit or a result of Fourier transform applied to the readout signal. Hereinafter, a configuration using a floating variation calculation method based on the control signal will be described as a third embodiment, and a configuration using a floating variation calculation method based on the Fourier transform result will be described as a fourth embodiment.

### [c] Third Embodiment

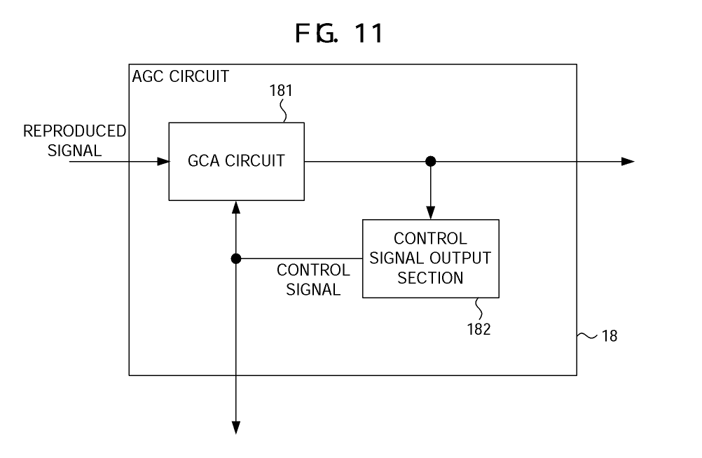

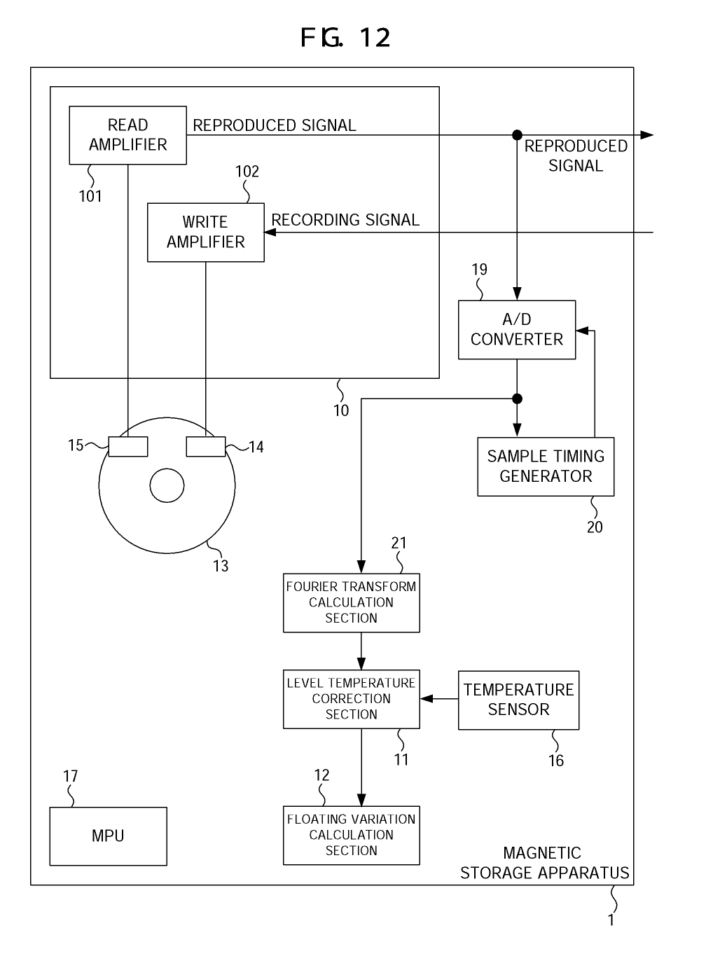

The third embodiment differs from the first and second embodiments in that the floating variation is calculated based on the control signal of the AGC circuit in place of the readout signal. Note that, in the present embodiment, the floating variation may be calculated using a method based on the reference information or method based on the correction information. Hereinafter, a description will be given of only the configuration and operation different from those of the first and second embodiments. FIG. 10 is a view illustrating a configuration of a magnetic storage apparatus according to the present embodiment. FIG. 11 is a block diagram illustrating a configuration of the AGC circuit.

As illustrated in FIG. 10, the magnetic storage apparatus 1 according to the present embodiment differs from those of the first and second embodiments in that it includes an AGC circuit 18 (measurement section) and an A/D converter 19 (measurement section).

As illustrated in FIG. 11, the AGC circuit 18 is constituted by a GCA circuit 181 and a control signal output section 182. The GCA circuit 181 adjusts the amplifier gain of a reproduced signal (readout signal) based on a control signal output from the control signal output section 182 and amplifies the readout signal by the adjusted amplifier gain so as to output it. The control signal output section 182 creates a control signal for keeping the signal level of the readout signal constant and outputs it. The control signal output section 182 may create the control signal by using a method disclosed in Japanese Laid-open Patent Publication No. 54-091165.

The A/D converter 19 converts the control signal output from the control signal output section 12 into a digital signal.

In the present embodiment, a relationship between the control signal level and ambient temperature has previously been recorded as the reference information or correction information in the magnetic disk 13. Based on the control signal level in place of the readout signal level, TAA1 and TAA2 can be obtained as follows by the level temperature correction section 11 and floating variation calculation section 12.

TAA1=a×bexp(G1)

TAA2=a×bexp(G2)

(a and b are constant numbers, and G1 and G2 are control signal levels)

Thus, the floating variation can be calculated in the same manner as the first and second embodiments.

As described above, according to the present embodiment, the floating variation can be calculated based on the level of the control signal output from the AGC circuit 18 in place of the readout signal.

### [d] Fourth Embodiment

The fourth embodiment differs from the above first to third embodiments in that the floating variation is calculated based on a result of Fourier transform applied to the readout signal. As in the case of the third embodiment, the floating variation may be calculated using a method based on the reference information or method based on the correction information. Hereinafter, a description will be given of only the configuration and operation different from those of the first to third embodiments. FIG. 12 is a view illustrating a configuration of a magnetic storage apparatus according to the present embodiment.

As illustrated in FIG. 12, the magnetic storage apparatus 1 according to the present embodiment differs from those of the first to third embodiments in that it includes a sample timing generator (measurement section) 20 and a Fourier transform calculation section 21 (measurement section). Further, the magnetic storage apparatus 1 according to the present embodiment differs from those of the first and second embodiments in that it includes the A/D converter 19 (measurement section). The function of the Fourier transform calculation section 21 is essentially executed by the MPU 17.

The sample timing generator 20 outputs a predetermined sample timing. Based on the sample timing, the A/D converter 19 digital converts a reproduced signal (readout signal) output from the AGC circuit to output a discrete digital sampling value. It is only necessary that the sample frequency be two or more times higher than the frequency of the F2 signal as the readout signal. In the present embodiment, the sample frequency is set to a frequency four times higher than the frequency of the F2 signal. The operation of the sample timing generator 20 is carried out according to a method disclosed in, e.g., Japanese Laid-open Patent Publication No. 2004-71060.

The Fourier transform calculation section 21 applied Fourier transform to a signal of the digital sampling value output from the A/D converter 19 to calculate the amplitude value of the linear fundamental wave of the F2. The amplitude value is calculated by using a method disclosed in Japanese Laid-open Patent Publication No. 09-312073. That is, the Fourier transform calculation section 22 calculates the cosine and sine coefficients of the F2 signal component based on the digital sampling value and calculates the square root of the square sum of these coefficients to thereby obtain the amplitude (amplitude of the linear fundamental wave) of the F2 signal.

In the present embodiment, a relationship between the amplitude value of the linear fundamental wave and ambient temperature has previously been recorded as the reference information or correction information in the magnetic disk 13. Based on the amplitude value in place of the readout signal level, the floating variation is calculated by the level temperature correction section 11 and floating variation calculation section 12 in the same manner as the first and second embodiments.

As described above, according to the present embodiment, the floating variation can be calculated based on a result of the Fourier transform applied to the readout signal in place of the readout signal.

Although the reference information and correction information have previously been recorded in the magnetic disk 13 in the above embodiments, they may be recorded in a non-volatile memory, if provided in the magnetic storage apparatus 1.

As described above, according to the present invention, it is possible to measure the floating variation of a magnetic head with high accuracy. The present invention can be embodied in various forms, without departing from the spirit or the main feature. Therefore, the aforementioned embodiments are merely illustrative of the invention in every aspect, and not limitative of the same. The scope of the present invention is defined by the appended claims, and is not restricted by the description herein set forth. Further, various changes and modifications to be made within the scope of the appended claims and equivalents thereof are to fall within the scope of the present invention.

According to the present embodiment, it is possible to effectively calculate the importance of a document considering the influence of parameters concerning the document.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A method for measuring a variation in the floating amount of a magnetic head for use in a magnetic storage apparatus that records a signal onto a magnetic recording medium using the magnetic head, the method comprising:
measuring the ambient temperature which is a temperature of the magnetic storage apparatus;
reading a signal recorded in the magnetic recording medium;
measuring a signal value which is a value related to a signal read in the reading; and
calculating a variation in the floating amount of the magnetic head based on relationship information which is information representing a relationship between the ambient temperature and signal value that have previously been measured, measurement value which is the ambient temperature measured in the measuring of the temperature, and signal value measured in the measuring of the signal.

2. The method for measuring a variation in the floating amount according to claim 1, wherein
the recorded signal is a signal of a predetermined frequency.

3. The method for measuring a variation in the floating amount according to claim 1, wherein
the relationship information is information representing a correspondence between the ambient temperature and signal value at the ambient temperature, and
the calculating calculates a variation in the floating amount of the magnetic head based on a signal value corresponding to the measurement value in the relationship information and signal value measured in the measuring of the signal.

4. The method for measuring a variation in the floating amount according to claim 1, wherein
the relationship information is information representing a correspondence between the ambient temperature and a ratio relative to a signal value at a predetermined temperature, and
the calculating calculates a variation in the floating amount of the magnetic head based on a signal value corresponding to the predetermined temperature and signal value that has been measured in the measuring of the signal and corrected based on a ratio that corresponds to the measurement temperature in the relationship information.

5. The method for measuring a variation in the floating amount according to claim 1, wherein
the measuring of the signal sets the level of the signal read in the reading as the signal value.

6. The method for measuring a variation in the floating amount according to claim 2, wherein
the predetermined frequency is a frequency ½ of that of the Nyquist frequency.

7. The method for measuring a variation in the floating amount according to claim 1, wherein
the reading reads a recorded preamble signal on the magnetic recording medium.

8. The method for measuring a variation in the floating amount according to claim 1, wherein
the measuring of the signal sets the level of a control signal for keeping the level of the signal read in the reading constant as the signal value.

9. The method for measuring a variation in the floating amount according to claim 1, wherein
the measuring of the signal applies Fourier transform to the signal read in the reading and sets a result obtained by the Fourier transform as the signal value.

10. The method for measuring a variation in the floating amount according to claim 1, wherein
the calculating calculates a variation in the floating amount according to Wallace's formula.

11. A magnetic storage apparatus that records a signal onto a magnetic recording medium, comprising:
a temperature measurement section that measures the ambient temperature which is a temperature of the magnetic storage apparatus;
a magnetic head that reads a signal recorded in the magnetic recording medium;
a measurement section that measures a signal value which is a value related to a signal read by the magnetic head; and
a calculation section that calculates a variation in the floating amount of the magnetic head based on relationship information which is information representing a relationship between the ambient temperature and signal value that have previously been measured, measurement value which is the ambient temperature measured by the temperature measurement section, and signal value measured by the measurement section.

12. The magnetic storage apparatus according to claim 11, wherein
the recorded signal is a signal of a predetermined frequency.

13. The magnetic storage apparatus according to claim 11, wherein
the relationship information is information representing a correspondence between the ambient temperature and signal value at the ambient temperature, and
the calculation section calculates a variation in the floating amount of the magnetic head based on a signal value corresponding to the measurement value in the relationship information and signal value measured by the measurement section.

14. The magnetic storage apparatus according to claim 11, wherein
the relationship information is information representing a correspondence between the ambient temperature and a ratio relative to a signal value at a predetermined temperature, and
the calculation section calculates a variation in the floating amount of the magnetic head based on a signal value corresponding to the predetermined temperature and signal value that has been measured by the measurement section and corrected based on a ratio that corresponds to the measurement temperature in the relationship information.

15. The magnetic storage apparatus according to claim 11, wherein
the measurement section sets the level of the signal read by the magnetic head as the signal value.

16. The magnetic storage apparatus according to claim 12, wherein
the predetermined frequency is a frequency ½ of that of the Nyquist frequency.

17. The magnetic storage apparatus according to claim 11, wherein
the magnetic head reads a recorded preamble signal on the magnetic recording medium.

18. The magnetic storage apparatus according to claim 11, wherein
the measurement section sets the level of a control signal for keeping the level of the signal read by the magnetic head constant as the signal value.

19. The magnetic storage apparatus according to claim 11, wherein
the measurement section applies Fourier transform to the signal read by the magnetic head and sets a result obtained by the Fourier transform as the signal value.

20. The magnetic storage apparatus according to claim 11, wherein
the calculation section calculates a variation in the floating amount according to Wallace's formula.
